(19) United States
(12) Patent Application Publication
(10) Pub. No.: US 2013/0184999 A1
(43) Pub. Date: Jul. 18, 2013

(54) SYSTEMS AND METHODS FOR CANCER-SPECIFIC DRUG TARGETS AND BIOMARKERS DISCOVERY

(71) Applicant: Yan Ding, Lexington, MA (US)

(72) Inventor: Yan Ding, Lexington, MA (US)

(21) Appl. No.: 13/732,645

(22) Filed: Jan. 2, 2013

Related U.S. Application Data
(60) Provisional application No. 61/583,272, filed on Jan. 5, 2012.

(51) Int. Cl. G06F 19/18

(52) U.S. Cl. CPC G06F 19/18
USPC 702/19

(57) ABSTRACT

The present invention provides users with cloud-based high throughput computing system for integrative analyses of next generation sequencing genomic data, such that human cancer biomarkers and drug targets can be accurately and quickly identified. Advantageously, the present invention harness a comprehensive systematic analysis pipelines for all types of next generation sequencing genomic data, advanced genomic variants calling algorithms and modeling, variant data correlation and integration, and identification of cancer specific biomarkers and therapeutic targets. Thus, the present invention will aid users so that less of their time and efforts are required in order to obtain precisely the desired information for which they are analyzing.

### CROSS REFERENCE TO RELATED APPLICATION

This application claims the benefit of U.S. Provisional Patent Application No. 61/583,272, filed on Jan. 5, 2012, the contents of which are incorporated herein by reference.

### BACKGROUND OF THE INVENTION

1. Field of the Invention

The present invention relates to systems and methods for enabling a user to analyze genomic next generation sequencing data in an integrative way, and quickly and accurately identify/find human cancer biomarkers and drug therapeutic targets for cancer diagnosis and therapeutics through Cloud-based computing via the Internet. The system is referred to herein as: OncoDecoder (which stands for oncology-decoder).

2. Discussion of the Background

Recent emerging technologies for genome next generation sequencing (NGS) revolutionize the way biotech and pharmaceuticals to identifying new drug targets and biomarkers. NGS has been applied to genome (DNA-seq), transcriptome (RNA-seq, miRNA-seq and lincRNA-seq), methylome (Methylation-seq), and protein-DNA interaction (CHIP-seq). However, the NGS data generated from the NGS platforms are usually huge in size up to 300 GB per genome, and has been bottleneck for practical NGS application. The ability of the scientific community to utilize the NGS data relies almost completely on well-established NGS analysis software, such as CLCbio Genomics Workbench, Galaxy, Genomatix, JMP Genomics, NextGENe, SeqMan Genome Analyzer, but these are of extremely limited scope.

Unfortunately, a user-friendly automatic integrative system capable of analyzing, correlating and integrating NGS data from DNA-seq, RNA-seq, miRNA-seq, lincRNA-seq, Methylation-seq, and CHIP-seq as well as clinical responses/drug sensitivity information to provide cancer-specific drug targets and biomarkers has yet to be introduced.

One disadvantage of conventional NGS data analysis systems, such as CLCbio Genomics Workbench, Galaxy, Genomatix, JMP Genomics, NextGENe, SeqMan Genome Analyzer, is that they can only process one data type at a time with no correlations between two different data types.

Another disadvantage of conventional NGS data analysis systems described above is that they can only provide primary and/or secondary NGS data analysis. They cannot provide tertiary data analysis nor disease-level target identification and biomarker findings.

Existing NGS data analysis systems do not provide distinguishing analysis for driver mutations (causally implicated in oncogenesis) and passenger mutations (a by-product of cancer cell development).

Additionally, the current available NGS data analysis systems cannot warrant for high sensitivity and specificity of cancer-specific target identification and biomarker discovery.

Another drawback of existing NGS data analysis systems is that they don't have the capacity to predict experimental compounds sensitivity for drug discovery screening. Therefore, the usability of the conventional NGS systems for drug discovery process is limited.

Moreover, the currently available NGS data analysis systems do not provide clinical drug responses/resistance prediction capability, thus, their clinical usage for translational medicine is limited.

Additionally, conventional NGS data analysis systems do not provide cancer molecular subtype classification and prognosis monitoring capacity. Therefore, their clinical application in cancer subtyping and prognosis is limited.

Current available systems do not provide multiple sample comparison, especially tumor/normal group sample comparisons for cohort studies/clinical trials.

Another drawback of conventional NGS data analysis systems is that they require expensive hardware and computing servers and results in limited data processing and data storage capacity. This essentially makes the NGS adoption impossible for small organizations or business entities with limited funding situation.

Moreover, conventional NGS data analysis systems are stand-alone applications reside on decentralized computing facility with difficulty to share data and results.

Furthermore, currently available NGS data analysis systems do not provide sample data analysis tracking mechanisms to allow users to track the data analysis progress and status.

In addition, conventional NGS data analysis systems work for only specific sequencing data format. They are not compatible to all common sequencing platforms.

What is desired, therefore, are NGS data analysis systems and methods to overcome the above described and other disadvantages of the conventional NGS data analysis system and methods.

### SUMMARY OF THE INVENTION

In short, the present invention is to provide a new system for analyzing next generation sequencing genomic data in an integrative approach to help users quickly and accurately identify/discovery human cancer biomarkers and drug therapeutic targets for cancer diagnosis and therapeutics. The new invention that has many advantages, novel features and functions is not anticipated, rendered obvious, suggested, or even implied by any of the prior art next generation sequencing data analysis systems, either alone or in any combination thereof.

In one embodiment, the present invention provides systems and methods for quick and accurate processing of various types of next generation sequencing data in a newly integrative way for human cancers drug target discovery and/biomarker identification. The present invention generally comprises the following steps: collecting cancer and paired normal samples from cancer patients at the sites including but not limited to research lab and hospital; transferring the samples to designated next generation sequencing lab for sequencing that includes genome sequencing (whole genome sequencing, exome sequencing, and target sequencing), transcriptome sequencing (RNA-seq, miRNA-seq, lincRNA-seq), CHIP-seq, methylation-seq; uploading the raw sequencing data from sequencers to Amazon Cloud Computing data center; distributing the sequence data to corresponding next generation sequencing data analysis pipelines for data processing to derive significant genomic mutations (DNA SNPs, indels, copy number variations (CNVs), structural variations (chromosomal translocation, inversion, duplication, large indels), differential gene expression, allele-specific gene expression, alternative splicing, gene fusion, miRNA expression, novel RNA target prediction, lincRNA expression and differential expression, significant cancer pathway alterations, gene ontology and annotations; correlation analysis between each related data types to derive significant events (e.g. significant mutations); statistical analysis across a set of samples, both within each data type, and across data types to derive significant event; integrative analyses that incorporates prior knowledge of the disease biology to generate curated disease-level observations include, but not limited to, cancer-specific biomarkers, drug targets, patient drug resistance profile, cancer subtypes and prognosis predictions; generating a human-readable report in an intuitive user-friendly format to facilitate and enable users to identify significant genomic alterations in a given cancer as drug target or biomarkers for validation. All above mentioned data analysis pipelines were implemented with proved algorithms, and conducted on Amazon Cloud Computing platform.

In one aspect, the present invention provides systems and methods to process all type of next generation sequencing data including DNA-seq, RNA-seq, miRNA-seq, IincRNA-seq, Methylation-seq, and CHIP-seq for cancer genome in an integrative way.

In another aspect, the present invention provide automatic tertiary level and disease-level data analysis algorithms by integrating the above described next gen sequencing data types to help user identify/discover novel therapeutic drug target and cancer biomarkers.

Advantageously, the present invention provides methods and algorithm to distinguish driver mutations from passenger mutations using machine learning approach.

Additionally, the present invention provides enhanced variant calls sensitivity and specificity through improved algorithms, rigorous quality assurance and filtering processes.

In another aspect, the present invention provides algorithms and methods by implementing collective genomic variations features, cancer pathways and drug responses assays to predict experimental compounds sensitivity for drug discovery screening.

In another aspect, the present invention correlates clinical responses profiles with significant genomic variation to provide drug resistance prediction capabilities to users. Physicians could use the information to select optimal personalized treatment for cancer patients.

In another aspect, the present invention provides methods and clustering algorithms for cancer molecular subtype classification and prognosis predictions. The outputs can help user to select corresponding drugs for targeted therapies based upon the cancer subtypes as well as monitoring the treatment progress based on the output of prognosis predictions.

In another aspect, the present invention provides multiple sample comparison including tumor/normal pair comparison.

In another aspect, the present invention can be deployed on Amazon Cloud-based Computing platform which enables high throughput of multiple samples NGS data processing with minimal hardware requirements and maintenance.

In another aspect, the present invention allows user from anywhere, at any time, to access the computing facility and data/results securely by using Cloud Computing technology.

In another aspect, the present invention provides sample data analysis progress and status tracking mechanism to allow user to track what processes are running, what goes wrong, and the status.

Additionally, the present invention enables to process all major sequencing platforms data format, and produce output files in standard formats for external tools compatibility.

The above and other features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 shows a flow chart illustrating a process according to an embodiment of the present invention.

FIG. 2 is a functional block diagram illustrating the Amazon Cloud Computing platform and the connections/communications between various users and the central computing facility of the present invention.

FIG. 3 is a diagram illustrating Cloud Computing deployment process of the present invention.

FIG. 4 is a diagram illustrating central computing facility of the present invention.

FIG. 5 is a sample report of a representative NGS data analysis process of the present invention.

### DETAILED DESCRIPTION OF THE PREFERRED EMBODMENT

In the following description, for purposes of explanation and not limitation, specific details are set forth, such as particular systems, computers, devices, components, techniques, computer language, algorithms, software products and systems, hardware, etc. in order to provide a thorough understanding of the present invention. However, it will be apparent to skilled in the art that the present invention may be practiced in other embodiments that depart from these specific details. Detailed descriptions of well-known systems, computers, devices, components, techniques, computer language, algorithms, software products and systems, hardware are omitted so as not to obscure the description of the present invention.

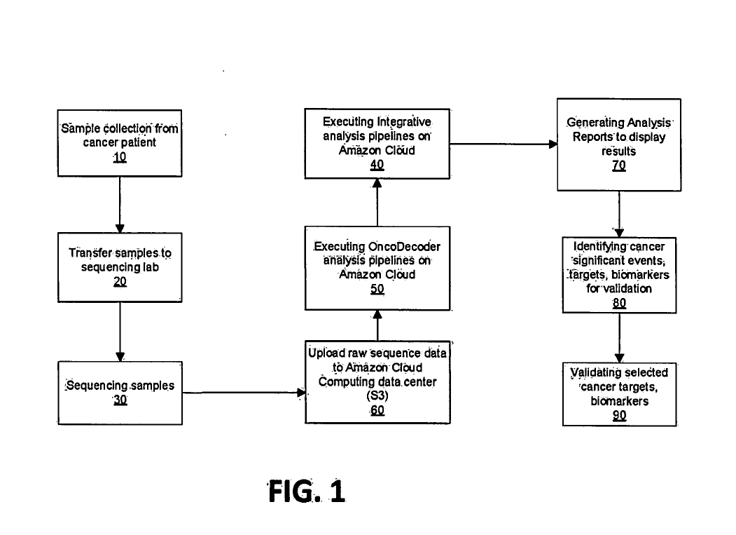

Turn now descriptively to the drawings, in which similar reference characters denote similar elements throughout the several view. FIG. 1 illustrates the workflow of the present invention as a cloud-based next generation sequencing, data analysis, sample tracking and reporting system, which comprises the process of collecting sample from cancer patient 10 at the sites, transferring the collected samples to sequencing laboratory 20, sequencing the samples 30, uploading raw sequence data to Cloud Computing data center 40, executing OncoDecoder 110 analysis pipelines as a Central Computing Facilities on the Cloud 50, executing integrative analysis pipelines on the Cloud 60, generating analysis reports to display results 70, based on the displayed results in report, end users can identify cancer specific significant events, targets, biomarkers for validation 80, and end users then validate the selected cancer targets/biomarkers 90.

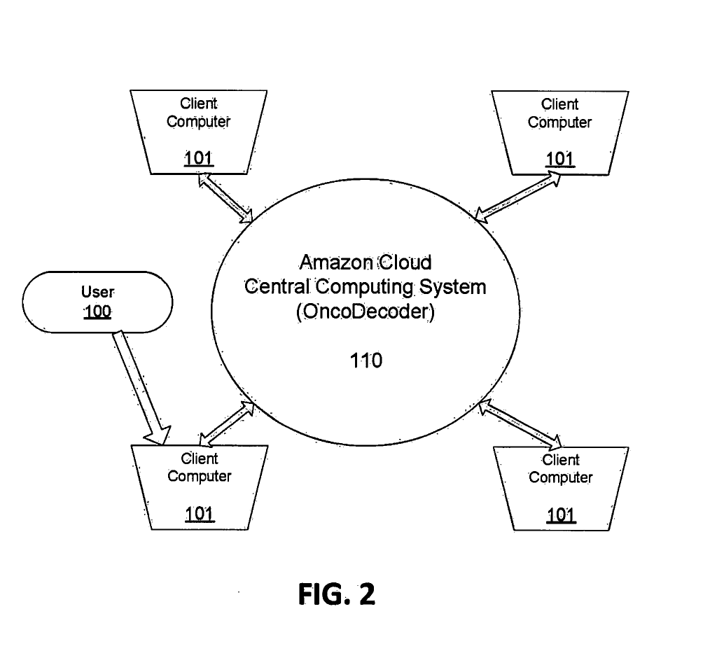

The present invention provides an automatic NGS data processing and integrative analysis systems implemented with novel algorithms and methods, which enables user to find cancer-specific drug targets and biomarkers, define cancer molecular subtypes, predict drug response profiles (see FIG. 2), which is referred to herein as OncoDecoder 110, which is the Central Computing system to process all aspects of next generation sequence data on the Cloud. OncoDecoder 110 can be used to process and analyze NGS data pertaining to any subject area, such as cardiovascular diseases, genetic diseases, neurological diseases, etc. For the purpose of illustration, and not limitation, a single application of OncoDecoder 110 will be described herein. More specifically, we will describe how OncoDecoder 110 can be used to analyze NGS data pertaining to cancer.

A user 100, a subscriber of OncoDecoder 110, who is processing and analyzing NGS data, may log into designed user account of OncoDecoder 110 on the Cloud, and may execute the Cloud commands to deploy and start OncoDecoder 110 for NGS data processing. User 100 may use a client device 101 (e.g. a personal computer) to execute OncoDecoder 110 via the Internet 111 or other network (or the OncoDecoder system may be locally installed on user 100′s device 101).

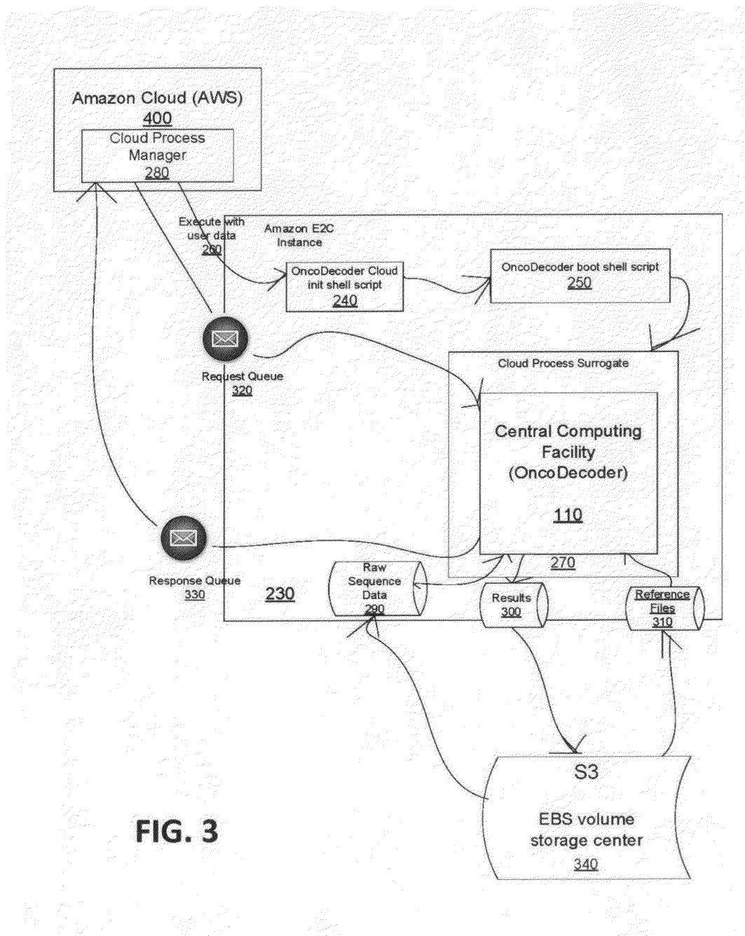

After user 100 executes Cloud commands, OncoDecoder 110 is executed through Cloud Process Manager 280 that resides on Amazon Cloud Computing service (AWS) 400 (see FIG. 3). FIG. 3 is a diagram illustrating Cloud Computing deployment of OncoDecoder 110. 400 is Amazon Cloud computing service (AWS), which is provided by Amazon as service provider. 280 is the cloud process manager that delegates the commands to operate Amazon E2C instances 230, and control messaging communications between the AWS and E2C instance. 240 is a shell script that initiates OncoDecoder cloud command with user data 260. 250 is a shell script that acts as boot up command to trigger specific data analysis pipeline(s) within OncoDecoder 110. 270 is the Cloud Process Surrogate as OncoDecoder container within in given JVM instance. 320 is the request queue containing sample data processing request message to communicate with Central Computing facility. 330 is the response queue containing sample data processing status and record tracking response message to send it back to Cloud Process Manager 280. 290 is raw sequence data downloaded from AWS EBS volume storage center (S3) 340 to a given E2C instance 230. 340 is Amazon S3 EBS volume storage center. 300 is the placeholder for analysis results and reports. 310 is placeholder for all genome reference files. Cloud process manager 280 invokes an Amazon E2C instance 230 through the execution of user-data followed by executing oncodecoder-cloud-init shell script 240 which contains commands to extract common E2C libraries, APIs, scripts and packages such as JDK from AWS into the created E2C instance 230, then an instance of oncodecoder-boot-script 250 is executed by oncodecoder-cloud-init shell script 240. Oncodecoder-boot-script 250 further execute OncoDecoder 110 instance contained in Cloud Process Surrogate 270 by receiving the message from Request Queue 320. OncoDecoder 110 take snapshot of raw sequence data 290 and snapshot of Reference Files 310 from EBS volume S3 340. Once data analysis is done, OncoDecoder 110 take snapshot of the results and upload to S3 EBS volume 340, then sends status message through response queue back to Cloud Process Manager 280, and shut down the E2C instance 230. The present invention is extremely cost-effective which require minimal computer hardware and maintenance, meanwhile allows for virtually unlimited number of users around the world to have instant access to results quickly and accurately 24 hours a day.

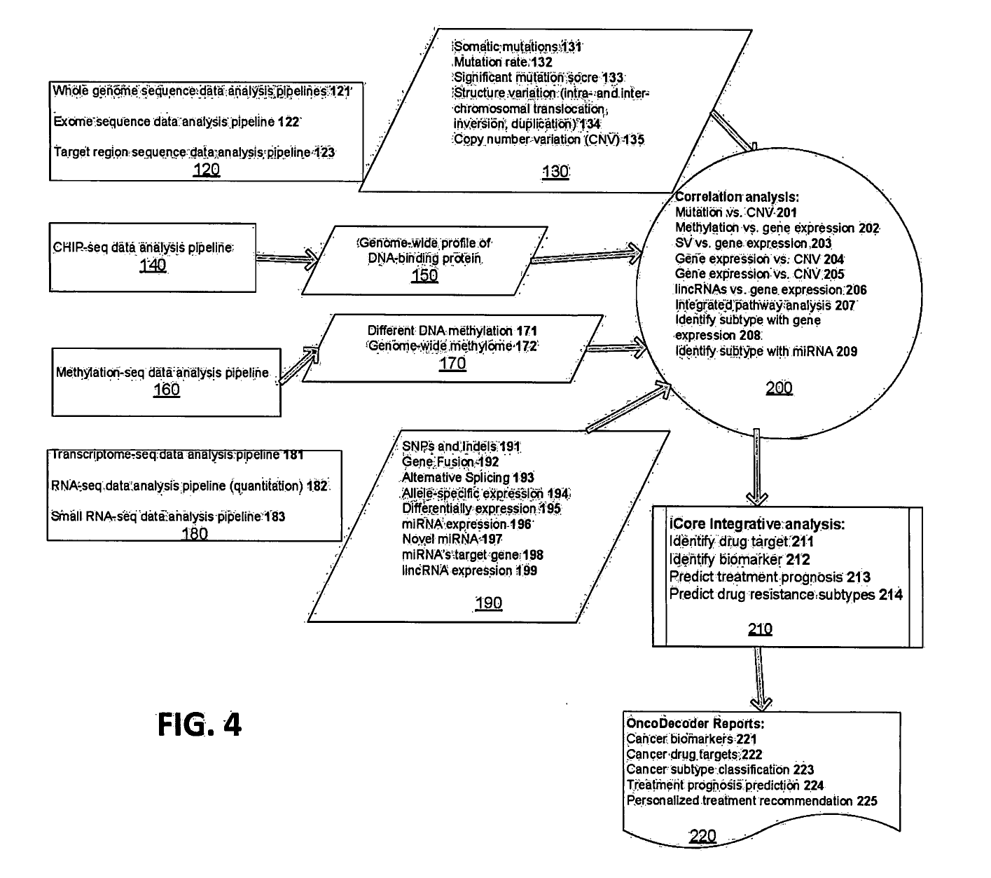

FIG. 4 is a diagram illustrating OncoDecoder 110 as the core of the present invention. 120 is a computational module implemented three genome DNA sequencing data analysis pipelines including whole-genome sequencing 121, exome sequencing 122 and target region sequence 123 data analysis pipelines. The outputs of module 120 includes quality control (QC) and quality assurance (QA) of sequencing data, DNA mutations(SNPs, indels) 131, mutation rate 132, significant mutation scores 133, structural variations 134 (inter-and intra-chromosomal translocation, inversion, duplication, large indels), and copy number variations 135 (CNVs). Module 120 enables a user to identify non-silent somatic mutations and genes with significant mutation frequency above background from a collection of tumors and their matched normal DNA. Information of potential protein functional impact based on the amino acid change, frame shift, silent, splice site and nonsense mutations is captured. Then the module 120 calculates the background mutation rate.

In one embodiment, module 120 calculates p-values according to a global background mutation rate with all mutations are treated equally.

In another embodiment, module 120 calculates significant mutation score for each gene based on its likelihood to be accrued the observed mutations by chance.

In another embodiment, module 120 generates a list of somatic mutations by comparing the features in the tumor and matched normal pairs. It calculates LOD score for each position to examine the possibility of a SNP at that position, and then calculates the LOD score for the same position from the normal to make certain the mutation is somatic.

In another embodiment, module 120 within OncoDecoder 110 classifies inter-chromosomal read-pairs into different categories by examining their separation distance by the fragment length of the library. Class I reads are normal read-pairs separated by fragment length of about 400 bp, class II reads are read-pairs with (10˜100 kB apart), class III reads are usually (>100 kb apart), and class IV reads are those ends mapped to different chromosomes. Then, module 120 examines the abnormal read-pairs for statistically significant evidence of chromosomal rearrangements such as inter- and intra-chromosomal translocations, inversions, duplications, and large indels. Candidate rearrangements between distant genomic windows must be supported by at least four bridging read-pairs.

In another embodiment, module 120 within OncoDecoder 110 examines the somatic copy number variations of genomic sequences through comparison of the sequence reads density of a tumor and it matched normal sample. First, a list of candidate breakpoints is generated by comparing the local difference in read counts on either side of the breakpoint, using a lenient genome wide significance threshold. Then low-significance segments are merged until a stringent p-value cutoff is reached.

In another embodiment, 140 is a computational module of OncoDecoder 110 that contains CHIP-seq sequence data analysis pipeline to process CHIP-seq sequence data for transcription factor-binding protein finding. Component 150 is analysis result for CHIP-seq 140, which contains quality control (QC) and quality assurance (QA) of sequencing data, genome-wide profile of DNA-binding protein.

In another embodiment, 160 is a computational module of OncoDecoder 110 that contains methylation-seq data analysis pipeline to process methylation-seq data for DNA methylation profiling. Component 170 is analysis results for methyl-seq, which contains quality control (QC) and quality assurance (QA) of sequencing data, different DNA methylation and genome-wide methylome profiles.

In another embodiment, 180 is a computational module of OncoDecoder 110 that contains transcriptome-seq, RNA-seq for quantitation, small RNA-seq, ncRNA-seq data analysis pipelines. Component 190 is analysis results for RNA sequencing data analysis module 180, which contains quality control (QC) and quality assurance (QA) of sequencing data, SNPs/Indels 191, gene fusion 192, alternative splicing 193, allele-specific expression 194, differentially expression gene 195, miRNA expression 196, novel miRNA 197, miRNA's target gene 198, IincRNA expression and other ncRNA expression 199, etc.

In another embodiment, module 180 within OncoDecoder 110 calculates differential gene expression levels according to the read density and uniqueness of each transcript. First tabulates the number of observed uniquely mapped reads, and then normalized by the number of uniquely mapped simulated reads generated from that transcript.

In another embodiment, module 180 within OncoDecoder 110 identifies candidate gene fusions by examining discordant and non-aligned read-pairs. First, read-pairs for which both reads mapped uniquely to different transcripts are subjected to a relaxed alignment allowing indels, to remove read pairs which could have arisen from the same transcript. Read-pairs within 1 Mb are set aside as potential read-through events or unannotated transcripts. For every pair of genes implicated by at least 2 distinct read-pairs, the set of previously non-aligning individual reads is searched for any read composed of the 3′ end of any exon in the first gene joined to the 5′ end of any exon in the second gene. Any pair of genes supported by ≧ read-pairs and ≧1 fusion-spanning individual read are nominated as candidate gene fusions.

In another embodiment, component 200 is a computational module of OncoDecoder 110 that contains correlation pipelines including correlation with mutation and copy number (CNV) 201, correlation with methylation and gene expression 202, correlation with structural variations (SVs) and gene expression 203, correlation with gene expression and CNV 204, correlation with miRNA and gene expression 205, correlation with lincRNA and gene expression 206, identification of cancer-specific pathway alterations 207, classifying cancer subtype using gene expression data 208, and classifying cancer subtype using miRNA expression data 209.

In one embodiment, module 201 implemented chi square statistical method to correlate with copy number and gene mutations was determined by comparing each subtype versus the remaining three subtypes.

In another embodiment, module 202 implemented correlation coefficient and supervised and unsupervised clustering algorithms to associate of DNA methylation with gene expression to define the cancer-associated epigenetic silencing of genes by examining the genes with evidence for cancer-specific promoter hypermenthylation with an associated decrease in gene expression.

In another embodiment, module 203 implemented correlation coefficient and unsupervised clustering methods to associate of chromosomal structural variations with gene expression. p-values are calculated and FDR is used to adjust error rate.

In another embodiment, module 204 implemented correlation coefficient and unsupervised clustering methods to associate of copy number with gene expression. p-values are calculated and FDR is used to adjust error rate.

In another embodiment, module 205 implemented correlation coefficient and unsupervised clustering methods to associate of gene expression with miRNA expression. p-values are calculated and FDR is used to adjust error rate.

In another embodiment, module 206 implemented correlation coefficient and unsupervised clustering methods to associate of IincRNA with gene expression.

In another embodiment, component 207 of module 200 within OncoDecoder 110 implemented gene set enrichment algorithms (GSEA) along with MsigDB to identify significant cancer-specific pathway alterations using differential gene expression levels as input features.

In another embodiment, component 208 of module 200 within OncoDecoder 110 implemented Support Vector Machine (SVM) and Random Forest classifiers to predict cancer subtypes of unknown samples based on differential gene expression outputs from step 180 and clinical data.

In another embodiment, component 209 of module 200 within OncoDecoder 110 implemented NMF, consensus k-means clustering, or consensus hierarchical clustering algorithms to defined subtype assignments and cluster significance based on miRNA expression outputs from step 180 and clinical data.

In another embodiment, OncoDecoder 110 provides a computational module iCore 210 to perform systematic integration of different NGS data types from 130, 150, 170, 190, and clinical data as well as outputs from module 200. The major analytical components in iCore 210 of OncoDecoder 110 include: identify ‘driver’ and ‘passenger’ mutations 211, where the output of this module is to define candidate cancer-specific drug target/biomarker gene(s); integrative analysis of clinical features with significant mutation genes 212; integrative analysis of patient treatment prognosis with prognostic gene scoring followed by survival analysis 213; pathway-based subtype classifications and drug responses/resistance prediction 214; integrative genomic analysis for drug sensitivity in drug screening 215. An example output from iCore 210 could be: a gene is targeted for genomic deletion, inactivating mutations, promoter hypermethylation, alterations of miRNA expression, and/or transcriptional down-regulation in different tumor samples would collectively suggest that this gene is a candidate tumor suppressor gene, even if each type of genomic alterations may be infrequent.

In one embodiment, machine learning algorithms (Random Forest, Bayesian and SVM) was implemented in component 211 of the module iCore 210 within OncoDecoder 110 by using the gene significant mutation score combined with prior knowledge of protein/domain function and cancer pathways as input features to derive ‘driver’ and ‘passenger’ mutations.

In another embodiment, component 212 within module 210 implemented correlation coefficient and clustering algorithms to examine potential correlations between mutations in different genes, and between mutational data and clinical parameters. Outputs findings such as hypermutated genes may be significantly correlated with clinical treatment status or exposure to a particular mutagen.

In another embodiment, component 213 within module 210 implemented univariate regression statistical model to define prognostic gene signatures correlated with poor survival and good survival. Component 213 also calculates prognostic gene score, and then the sub-module 213 executes Kaplan-Meier survival analysis of the prognostic gene signatures, and then compares survival for predicted higher-risk patients versus lower-risk patients to predict new patient prognosis.

In another embodiment, component 214 within module 210 implements GSEA Pathway Feature (GPF) method, which used pathway features generated by combinations of GSEA leading edge genes and SVM gene weights, and GLEG (GSEA-based Leading Edge Gene feature) method with SVM along with clinical drug treatment status such as drug resistance and responses information to classify cancer subtypes and predict new patients treatment responses/resistance.

In another embodiment, component 215 within module 210 implements machine learning algorithms such as Bayesian, Random Forest, and SVM using gene expression level, DNA mutation, copy number variations, cancer pathway alterations, miRNA expression, methylation profiles, IC50, %inhibition data as input features to predict compounds sensitivities in high throughput screening (HTS) drug discovery process. The example output of the module 215 could be: a cancer cell line with cancer-specific gene mutation(s) or methylation silencing gene(s) in a cancer pathway has sensitive/refractory response to a compound at a certain concentration

In another embodiment, module 220 is the final outputs of integrative analysis results and OncoDecoder summary report, which contains quality control (QC) and quality assurance (QA) of sequencing data , candidate cancer biomarkers 221, candidate cancer drug targets (cancer-specific pathway and significant gene alterations) 222, cancer subtype classifications 223, treatment prognosis prediction 224, and personalized cancer treatment recommendations 225. The results from the report may include individual tumor sample analysis results as well as integrative analysis results from tumor/normal pairs and a cohort study.

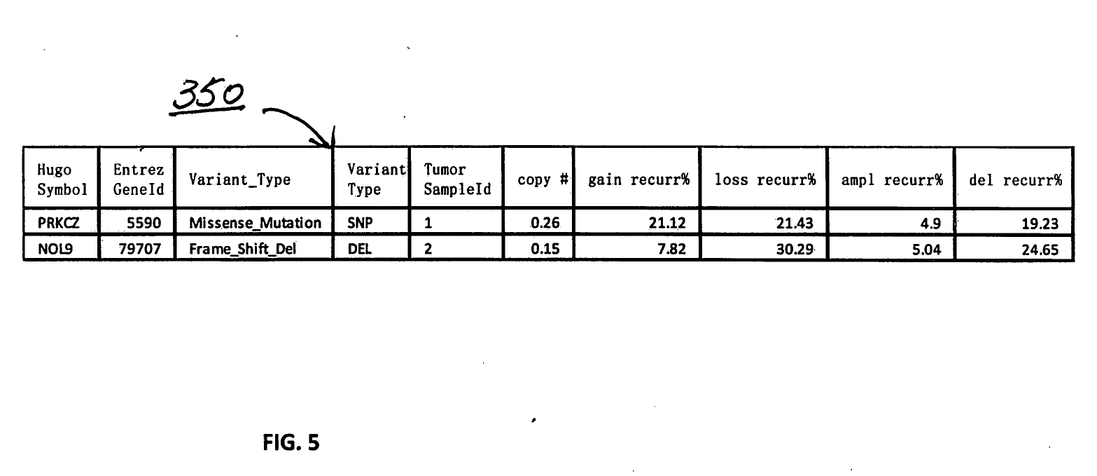

FIG. 5 illustrates an example NGS data analysis output that is presented to user 100 after correlation of DNA mutation with copy number 350 has been completed. As shown in FIG. 5, a variety of information about DNA mutation and copy number association may be presented to the user. For instance, the gene Hugo symbol, Entrez gene ID, mutation type (e.g. missense mutation or frame shift deletion), variant type (e.g. SNP or InDel), tumor sample ID, and its associated copy number changes such as copy number score, recurrence percentage gain, recurrence percentage loss, recurrence percentage amplification, and recurrence percentage deletion. For cohort study, correlation coefficient value will be calculated for significance analysis.

The systems, processes, and components set forth in the present description may be implemented using one or more general purpose computers, microprocessors, or the like programmed according to the teachings of the present specification, as will be appreciated by those skilled in the relevant art(s). Appropriate software coding can readily be prepared by skilled programmers based on the teachings of the present disclosure, as will be apparent to those skilled in the relevant art(s). The present invention thus also includes a computer-based product which may be hosted on a storage medium and include instructions that can be used to program a computer to perform a process in accordance with the present invention. The storage medium can include, but is not limited to, any type of disk including a floppy disk, optical disk, CDROM, magneto-optical disk, ROMs, RAMs, EPROMS, EEPROMS, flash memory, magnetic or optical cards, or any type of media suitable for storing electronic instructions, either locally or remotely.

While the processes described herein have been illustrated as a series or sequence of steps, the steps need not necessarily be performed in the order described, unless indicated otherwise. Also, while the modules of OncoDecoder 110 illustrated in FIG. 3 and FIG. 4 are shown as being separate entities, they need not be. As will be apparent to those skilled in the art of computer programming, a single piece of software or multiple pieces of software can implement the modules. If multiple pieces of software implement the modules, the pieces do not need to run on the same computer.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention. Obviously, numerous modifications and variations of the present invention are possible in light of the above teachings. It is therefore to be understood that the invention may be practiced otherwise than as specifically described herein.

Thus, the breadth and scope of the present invention should not be limited by any of the above-described exemplary embodiments, but should be defined only in accordance with the following claims and their equivalents.

What is claimed is:

1. A next generation sequencing (NGS) data analysis method, comprising:
analyzing the quality of NGS data to create matrix and graphs for alignment summary, quality score distribution, library insert size, GC Bias, mean quality by cycle, and duplicate reads;
analyzing the whole genome sequencing data to generate calls for somatic mutations, copy number variations (CNV), chromosomal rearrangement (translocation, inversion, large indels, and duplication), transition-transversion ratio, LOD, mutation rate, and significant mutation score; and/or
analyzing the whole exome sequencing data to generate calls for somatic mutations, transition-transversion ratio, LOD, mutation rate, and significant mutation score; and/or
analyzing the target region sequencing data to generate calls for somatic mutations, transition-transversion ratio, LOD, mutation rate, and significant mutation score;
analyzing the whole transcriptome-sequencing data for differential gene expression, gene fusion, alternative splicing, SNP, Indels, allele-specific gene expression; lincRNA and other ncRNAs expression, miRNA expression; and/or
analyzing the RNA-sequencing data for mRNA quantification, differential gene expression, gene fusion, alternative splicing, SNP, Indels, allele-specific gene expression, cancer subtyping; and/or
analyzing small RNA-sequencing data for miRNA expression, novel miRNA prediction, and mRNA target identification, cancer subtyping; and/or
analyzing CHIP-sequencing data to generate calls for genome-wide profile of DNA-binding protein and transcription factors;
analyzing Methylation-sequencing data to generate calls for differential DNA methylation and genome-wide methylation profiles;

2. The method claim 1, further comprising the step of classifying inter-chromosomal read-pairs into different categories based on the read-pairs separation distance by the fragment length of the library;

3. The method claim 1, further comprising the step of examining the somatic copy number variations of genomic sequences through comparison of sequence read density of a tumor and it matched normal sample. First, generates a list of candidate breakpoints by comparing the local difference in read counts on either side of the breakpoint, using a lenient genome wide significance threshold. Then low-significance segments are merged until a stringent p-value cutoff is reached;

4. The method claim 1, further comprising the step of calculating differential gene expression levels according to the read density and uniqueness of each transcript. First tabulates the number of observed uniquely mapped reads, and then normalized by the number of uniquely mapped simulated reads generated from that transcript;

5. The method claim 1, further comprising the step of identifying gene fusions by examining discordant and non-aligned read-pairs for which both reads mapped uniquely to different transcripts are subjected to a relaxed alignment allowing indels to remove read-pairs which could have arisen from the same transcript;

6. The method claim 1, further comprising the step of:
determining the correlation significance with copy number and gene mutations by comparing each subtype versus the remaining three subtypes;
defining cancer-associated epigenetic silencing of genes by examining the genes with evidence for cancer-specific promoter hypermenthylation with an associated decrease in gene expression;
determining the correlation significance with chromosomal rearrangements and gene expression;
determining the correlation significance with gene expression and copy number;
determining the correlation significance with gene expression and miRNA expression;
determining the correlation significance with gene expression and lincRNA expression;
identifying significant cancer-specific pathway alterations using gene set enrichment algorithms along with MsigDB with gene expression data as input features;
classifying cancer subtypes of unknown samples using SVM and Random Forest classifiers with gene expression and clinical data as input features;
classifying cancer subtypes of unknown samples using NMF, clustering algorithms using miRNA expression and clinical data data as input features;

7. The method claim 1, further comprising the step of:
identifying ‘driver’ mutation and ‘passenger’ mutation using machine learning algorithms with gene significant mutation score, prior knowledge of protein/domain function and cancer pathways as input features;
determining the correlation significance with clinical treatment status and significant mutated genes;
determining treatment prognosis using survival analysis, regression statistical model, and correlation algorithms with prognostic signatures, survival data, and clinical data;
classifying patient drug responses/resistance subtypes using GPF method combines with SVM gene weights, or GLEG method combines with SVM gene weights, and clinical treatment status, drug responses, gene expression levels, cancer-specific pathways as input features predicting in vitro and/in vivo studies compounds sensitivities using machine learning classifiers with gene mutation, cancer pathways, gene expression, cancer-specific promoter hypermenthylation, miRNA expression, IC50, % of inhibition, and COSMIC data as input features;
generating customized integrative analysis summary reports that contains user defined analytical results that may include, but not limited to, candidate cancer-specific pathway and significant gene alterations, cancer subtype classifications, treatment prognosis prediction, and personalized cancer treatment recommendations.

8. A next generation sequencing (NGS) data analysis system, comprising:
means for analyzing the quality of NGS data to create matrix and graphs for alignment summary, quality score distribution, library insert size, GC Bias, mean quality by cycle, and duplicate reads;
means for analyzing the whole genome sequencing data to generate calls for somatic mutations, copy number variations (CNV), chromosomal rearrangement (translocation, inversion, large indels, and duplication), transition-transversion ratio, LOD, mutation rate, and significant mutation score; and/or
mean for analyzing the whole exome sequencing data to generate calls for somatic mutations, transition-transversion ratio, LOD, mutation rate, and significant mutation score; and/or
means for analyzing the target region sequencing data to generate calls for somatic mutations, transition-transversion ratio, LOD, mutation rate, and significant mutation score;
means for analyzing the whole transcriptome-sequencing data for differential gene expression, gene fusion, alternative splicing, SNP, Indels, allele-specific gene expression; IincRNA and other ncRNAs expression, miRNA expression; and/or
means for analyzing the RNA-sequencing data for mRNA quantification, differential gene expression, gene fusion, alternative splicing, SNP, Indels, allele-specific gene expression, cancer subtyping; and/or
means for analyzing small RNA-sequencing data for miRNA expression, novel miRNA prediction, and mRNA target identification, cancer subtyping; and/or
means for analyzing CHIP-sequencing data to generate calls for genome-wide profile of DNA-binding protein and transcription factors;
means for analyzing Methylation-sequencing data to generate calls for differential DNA methylation and genome-wide methylation profiles;

9. The system claim 8, further comprising means of classifying inter-chromosomal read-pairs into different categories based on the read-pairs separation distance by the fragment length of the library;

10. The system claim 8, further comprising means for examining the somatic copy number variations of genomic sequences through comparison of sequence read density of a tumor and it matched normal sample. First, generates a list of candidate breakpoints by comparing the local difference in read counts on either side of the breakpoint, using a lenient genome wide significance threshold. Then low-significance segments are merged until a stringent p-value cutoff is reached;

11. The system claim 8, further comprising means for calculating differential gene expression levels according to the read density and uniqueness of each transcript. First tabulates the number of observed uniquely mapped reads, and then normalized by the number of uniquely mapped simulated reads generated from that transcript;

12. The system claim 8, further comprising means for identifying gene fusions by examining discordant and non-aligned read-pairs for which both reads mapped uniquely to different transcripts are subjected to a relaxed alignment allowing indels to remove read-pairs which could have arisen from the same transcript;

13. The system claim 8, further comprising:
means for determining the correlation significance with copy number and gene mutations by comparing each subtype versus the remaining three subtypes;
means for defining cancer-associated epigenetic silencing of genes by examining the genes with evidence for cancer-specific promoter hypermenthylation with an associated decrease in gene expression;
means for determining the correlation significance with chromosomal rearrangements and gene expression;
means for determining the correlation significance with gene expression and copy number;
means for determining the correlation significance with gene expression and miRNA expression;
means for determining the correlation significance with gene expression and lincRNA expression;
means for identifying significant cancer-specific pathway alterations using gene set enrichment algorithms along with MsigDB with gene expression data as input features;
means for classifying cancer subtypes of unknown samples using SVM and Random Forest classifiers with gene expression and clinical data as input features;
means for classifying cancer subtypes of unknown samples using NMF, clustering algorithms using miRNA expression and clinical data data as input features;

14. The system claim 8, further comprising:
means for identifying ‘driver’ mutation and ‘passenger’ mutation using machine learning algorithms with gene significant mutation score, prior knowledge of protein/domain function and cancer pathways as input features;
means for determining the correlation significance with clinical treatment status and significant mutated genes;
means for determining treatment prognosis using survival analysis, regression statistical model, and correlation algorithms with prognostic signatures, survival data, and clinical data;
means for classifying patient drug responses/resistance subtypes using GPF method combines with SVM gene weights, or GLEG method combines with SVM gene weights, and clinical treatment status, drug responses, gene expression levels, cancer-specific pathways as input features;
means for predicting in vitro and/in vivo studies compounds sensitivities using machine learning classifiers with gene mutation, cancer pathways, gene expression, cancer-specific promoter hypermenthylation, miRNA expression, IC50, % of inhibition, and COSMIC data as input features;
means for generating customized integrative analysis summary reports that contains user defined analytical results that may include, but not limited to, candidate cancer-specific pathway and significant gene alterations, cancer subtype classifications, treatment prognosis prediction, and personalized cancer treatment recommendations.

15. A computer program embodied on a computer readable medium, the computer program comprising:
a computer code segment for analyzing the quality of NGS data to create matrix and graphs for alignment summary, quality score distribution, library insert size, GC Bias, mean quality by cycle, and duplicate reads;
a computer code segment for analyzing the whole genome sequencing data to generate calls for somatic mutations, copy number variations (CNV), chromosomal rearrangement (translocation, inversion, large indels, and duplication), transition-transversion ratio, LOD, mutation rate, and significant mutation score; and/or
a computer code segment for analyzing the whole exome sequencing data to generate calls for somatic mutations, transition-transversion ratio, LOD, mutation rate, and significant mutation score; and/or
a computer code segment for analyzing the target region sequencing data to generate calls for somatic mutations, transition-transversion ratio, LOD, mutation rate, and significant mutation score;
a computer code segment for analyzing the whole transcriptome-sequencing data for differential gene expression, gene fusion, alternative splicing, SNP, Indels, allele-specific gene expression;
lincRNA and other ncRNAs expression, miRNA expression; and/or
a computer code segment for analyzing the RNA-sequencing data for mRNA quantification, differential gene expression, gene fusion, alternative splicing, SNP, Indels, allele-specific gene expression, cancer subtyping; and/or
a computer code segment for analyzing small RNA-sequencing data for miRNA expression, novel miRNA prediction, and mRNA target identification, cancer subtyping; and/or
a computer code segment for analyzing CHIP-sequencing data to generate calls for genome-wide profile of DNA-binding protein and transcription factors;
a computer code segment for analyzing Methylation-sequencing data to generate calls for differential DNA methylation and genome-wide methylation profiles;

16. The system claim 15, further comprising a computer code segment of classifying inter-chromosomal read-pairs into different categories based on the read-pairs separation distance by the fragment length of the library;

17. The system claim 15, further comprising a computer code segment for examining the somatic copy number variations of genomic sequences through comparison of sequence read density of a tumor and it matched normal sample. First, generates a list of candidate breakpoints by comparing the local difference in read counts on either side of the breakpoint, using a lenient genome wide significance threshold. Then low-significance segments are merged until a stringent p-value cutoff is reached;

18. The system claim 15, further comprising a computer code segment for calculating differential gene expression levels according to the read density and uniqueness of each transcript. First tabulates the number of observed uniquely mapped reads, and then normalized by the number of uniquely mapped simulated reads generated from that transcript;

19. The system claim 15, further comprising a computer code segment for identifying gene fusions by examining discordant and non-aligned read-pairs for which both reads mapped uniquely to different transcripts are subjected to a relaxed alignment allowing indels to remove read-pairs which could have arisen from the same transcript;

20. The system claim 15, further comprising:
a computer code segment for determining the correlation significance with copy number and gene mutations by comparing each subtype versus the remaining three subtypes;
a computer code segment for defining cancer-associated epigenetic silencing of genes by examining the genes with evidence for cancer-specific promoter hypermenthylation with an associated decrease in gene expression;
a computer code segment for determining the correlation significance with chromosomal rearrangements and gene expression;
a computer code segment for determining the correlation significance with gene expression and copy number;
a computer code segment for determining the correlation significance with gene expression and miRNA expression;
a computer code segment for determining the correlation significance with gene expression and lincRNA expression;
a computer code segment for identifying significant cancer-specific pathway alterations using gene set enrichment algorithms along with MsigDB with gene expression data as input features;
a computer code segment for classifying cancer subtypes of unknown samples using SVM and Random Forest classifiers with gene expression and clinical data as input features;
a computer code segment for classifying cancer subtypes of unknown samples using NMF, clustering algorithms using miRNA expression and clinical data data as input features;

21. The system claim 15, further comprising:
a computer code segment for identifying ‘driver’ mutation and ‘passenger’ mutation using machine learning algorithms with gene significant mutation score, prior knowledge of protein/domain function and cancer pathways as input features;
a computer code segment for determining the correlation significance with clinical treatment status and significant mutated genes;
a computer code segment for determining treatment prognosis using survival analysis, regression statistical model, and correlation algorithms with prognostic signatures, survival data, and clinical data;
a computer code segment for classifying patient drug responses/resistance subtypes using GPF method combines with SVM gene weights, or GLEG method combines with SVM gene weights, and clinical treatment status, drug responses, gene expression levels, cancer-specific pathways as input features;
a computer code segment for predicting in vitro and/in vivo studies compounds sensitivities using machine learning classifiers with gene mutation, cancer pathways, gene expression, cancer-specific promoter hypermenthylation, miRNA expression, IC50, % of inhibition, and COSMIC data as input features;
a computer code segment for generating customized integrative analysis summary reports that contains user defined analytical results that may include, but not limited to, candidate cancer-specific pathway and significant gene alterations, cancer subtype classifications, treatment prognosis prediction, and personalized cancer treatment recommendations.
